(19) United States
(12) Patent Application Publication
(10) Pub. No.: US 2024/0354920 A1
(43) Pub. Date: Oct. 24, 2024

(54) METHOD AND SYSTEM FOR GENERATING A CROP FAILURE MAP

(71) Applicant: BASF AGRO TRADEMARKS GMBH, Ludwigshafen (DE)

(72) Inventors: Ashish KASHAV, Frankfurt am Main (DE); Mauricio LOPES AGNESE, Im Zollhafen (DE); Sandra SELINGER, Koeln (DE); Vagner PASOLIUS WEXEL, Koeln (DE)

(21) Appl. No.: 18/574,239

(22) PCT Filed: Jun. 28, 2022
(86) PCT No.: PCT/EP2022/067793

§ 371 Date: Dec. 26, 2023

(30) Foreign Application Priority Data
Jun. 29, 2021 (EP) 21182433.9

(51) Int. Cl. G06T 7/00; G06T 7/60; G06V 10/774; G06V 10/82; G06V 20/10

(52) U.S. Cl. CPC G06T 7/0002; G06T 7/60; G06V 10/774; G06V 20/188; G06T 2207/10032; G06T 2207/20044; G06T 2207/20081; G06T 2207/20084; G06T 2207/30188; G06V 10/82

(57) ABSTRACT

A method for generating a crop failure map is provided. The method comprises providing annotated training data, the annotated training data comprising aerial images of zones of an agricultural field and the annotations relating to failures of the crops within the agricultural field, the crops being perennial crops. The method further comprises training an artificial intelligence with the annotated training data and providing field data, the field data comprising at least one aerial image of an agricultural field to be inspected. The trained artificial intelligence is run on the field data to generate a crop failure map. Also, a system for generating a crop failure map and a use of a crop failure map are provided.

### FIELD OF THE INVENTION

The present invention relates to digital farming. In particular, the present invention relates to the problem of detection of failures in sugarcane crops. These failures are gaps between a continuous crop line which depicts failure.

### BACKGROUND OF THE INVENTION

Nowadays, to maximize the productivity of crops in agriculture, methodologies are being developed which fall under the category called Precision Agriculture. The aim is to reduce production losses and get the knowledge of contributing factors.

A tool to get the field data are Unmanned Aerial Vehicle (UAV). The pictures captured by these drones can then later be analyzed for various use cases to provide precision agriculture. The whole technological pipeline can contribute to the efficiency and productivity of agricultural practices. Failures in planting are factors that contribute to decreased productivity in sugarcane. A fault is defined as the distance between two consecutive sugarcanes along the same crop line.

Detecting failures can be very useful for the farmers since they can replant those failed regions, especially around the tillering growth stage. Since the size of the field is huge and most plantations are done manually or in an automated way it is very difficult to move around the whole field to find failures and replant. Automated failure detections save time and resources to replant where ever needed.

Generally, crop failures are detected using classical computer vision methods (mostly line detection algorithms coupled with some morphological operations) but they are not very accurate and also do not work at all for use cases. Even if proper parameters for an image are found, it does not guarantee success for other images and those settings might fail miserably.

### SUMMARY OF THE INVENTION

In view of the above, it is an object of the present invention to provide a computer-implemented method which allows fast, accurate and high-precision identification of crop failure regions in an agricultural field. It is also an object of the present invention to provide a computer-implemented method which supports fast, real-time and/or efficient decision-making for a farmer or user regarding the treatment of an agricultural field, especially regarding re-planting of crops in the crop failure regions. It is also an object of the present invention to provide a computer-implemented method to minimize the re-planting effort and resources in an agricultural field.

The objects of the present invention are solved with the subject matter of the independent claims, wherein further embodiments are incorporated in the dependent claims. It should be noted that the following de-scribed aspects and examples of the invention apply for the method as well as for the data processing system, the computer program product and the computer-readable storage medium.

The present invention relates to a deep learning method for the automatic detection of sugarcane which predicts with higher precision and also works for most of the use cases hence generalizable.

According to the first aspect of the present invention, the present invention relates to a method for generating a crop failure map, the method comprising:
providing annotated training data, the annotated training data comprising aerial images of zones of an agricultural field and the annotations relating to failures of the crops within the agricultural field, the crops being perennial crops; training an artificial intelligence with the annotated training data; providing field data, the field data comprising at least one aerial image of an agricultural field to be inspected; running the trained artificial intelligence on the field data to generate an crop failure map.

In the context of the present invention, the crop failure map is preferably a 2-dimensional map which indicates crop failures or areas where crop failures occur within an agricultural field.

In a preferred embodiment of the present invention, the method further comprises: determining crop failure length by modifying the crop failure map by means of skeletonizing, line fitting and/or other means of crop failure length estimation.

In a further preferred embodiment of the present invention, the method further comprises: skeletonizing the crop failure map to generate a crop failure row map comprising rows of failures.

Failures are understood to be crop failures. Crop failure(s) is or are understood to be spaces or places-usually within crop rows—where seeded and/or planted crops did not emerge or grow.

In a further preferred embodiment of the present invention, the method further comprises: identifying crop failure regions in the crop failure map or crop failure row map and outputting a control file usable to control an agricultural equipment for re-planting crops in the identified crop failure regions. Crop failure regions are preferably automatically identified based on the different indications or identifiers within the crop failure map. In the context of the present invention, the term “control file” is any binary file, data, signal, identifier, information, or application map usable to control an agricultural equipment which is able to re-plant crops in the agricultural field. In a further preferred embodiment of the present invention, the control file is an application map. An agricultural equipment can preferably be a planter, planting machine, planting robot, or an unmanned vehicle or an unmanned aerial vehicle (such as a drone) which is capable of re-planting crops in an agricultural field.

In a further preferred embodiment of the present invention, the method further comprises: determining the crop failure percentage from the crop failure map for a plurality of sub-zones of the agricultural field; assigning the determined crop failure percentage to the sub-zones; and generating a crop failure percentage map indicating the crop failure percentage for each of the sub-zones.

In a further preferred embodiment of the present invention, the method further comprises: determining the crop map by means of indices calculation with thresholding or artificial intelligence and determining the crop length by modifying the crop map by means of skeletonizing, line fitting and/or other means of crop length estimation, determining the crop failure percentage from the crop failure map for a plurality of sub-zones of the agricultural field and from the crop map of the same area; assigning the determined crop failure percentage to the sub-zones; and generating a crop failure percentage map indicating the crop failure percentage for each of the sub-zones.

More preferably, indices calculation is done by calculating the excess green index (ExG), an index which is used to identify green pixels from a given image. More preferably, thresholding is done with Otsu thresholding, which is a well-known method named after Nobuyuki Otsu and which is used to perform automatic image thresholding. More preferably, “indices calculation with thresholding” is calculation of excess green index (ExG) with Otsu thresholding.

In a further preferred embodiment of the present invention, the sub-zones are squares and the squares have, in particular, an edge length of 10 meters or less, preferably enabling a user to point to the location of the failure and deciding on any necessary actions.

In a further preferred embodiment of the present invention, the sub-zones are squares and the squares have, in particular, an edge length of 10 m, preferably 5 m, more preferably 2 m.

In a further preferred embodiment of the present invention, the method further comprises:
providing initial annotated training data, the initial training data comprising aerial images of zones of an agricultural field and the annotations relating to failures of the crops within the agricultural field; and auto-augmenting the initial annotated training data to generate the annotated training data.

According to the second aspect of the present invention, the present invention relates to a system for generating a crop failure map, the system comprising:
an input unit for providing annotated training data and for providing field data; and a computing unit configured to execute the method according to the present invention.

According to the third aspect of the present invention, the present invention relates to a computer program element which when executed by a computing unit in a system according to the present invention is configured to carry out a method according to the present invention.

According to the fourth aspect of the present invention, the present invention relates to a computer readable medium that generates data to control a computing unit in a system according to the present invention according to the method according to the present invention.

According to the fifth aspect of the present invention, the present invention relates to the use of a crop failure map to identify crop failure regions of an agricultural field with perennial crops.

Regarding the use according to the present invention, crops are preferably re-planted in the identified crop failure regions.

The crop failure detection problem can be extended to other plantations also apart from sugarcane namely corn, coffee, and citrus plantations. The existence of failures in the cane fields is due to the occurrence of several factors like the quality of seedlings, stems distributed in the furrows, presence of pests or diseases, inadequate handling in the application of pesticides, excessive traffic of machines in the field, damages and concussions caused by the mechanized harvest, in short, countless factors and diminishing vigor of the plants with each harvest.

The problem here is to detect gaps in a continuous crop line which corresponds to a failure if its length is greater than 51 cm. From the whole field image patch of resolution 480×480 is extracted to train the semantic segmentation network and patches are hand labeled for possible failures. Here we use a Feature Pyramid network with Efficient-Net B1 backbone in addition to applying suitable image augmentations, trained on labeled crop failure data to predict segmentation maps, total failure length, and failure percentage of the field.

The images of the fields are collected by a sensor that is attached to a drone. These images are stitched to output a large-sized tif (Tagged Image Format) file from which 100 patches of 480×480 are extracted. The solution as the discussion above to stitch the images is readily available in the form of a mapper which is a 13 step process. Some patches, which correspond to surrounding things but are not the crops, are filtered out. There are preconditions for flying like once when flown it has to be at most 8 m/s speed else not stable to capture images. The best weather is overcast and if sunny then the vignette effect becomes stronger which is not good for the quality of images. Timewise it should be not too early in the morning nor late in the evening.

There are various growth stages of sugarcane crops. The dataset comprises a mixture of all the growth stages for adversarial training but our focus while making the prediction is on the tillering stage because at that stage farmer is most interested in deciding on the field. The dataset contains field data from around 80+ fields (around 4000 images) and a train validation split of 9:1 ratio is done. A specific test set having around 60 examples all coming from tillering stage to simulate real-time testing is also maintained.

The field data are gathered from various regions of Brazil such as São Paulo and Goiás and they do not differ from each other much. These data are annotated using an open-source image annotation tool to create training data for image segmentation and export annotations. Annotations were thoroughly reviewed by expert agronomists to ensure robustness. It has to be made sure here that all sort of failure are used, not just the only ones which are greater than 51 cm. The reason for this is that we want to reinforce into the model the capacity to detect all gaps in crop lines. This can be followed by post-processing steps which then filter out failure which is less than 51 cm. The problem here is transformed into a supervised semantic segmentation problem.

In a preferred embodiment of the present invention, the excess green index (ExG) is used to identify green pixels from a given image. It is defined as follows: ExG=2g−r−b, where r, g, and b in RGB color space are normalized colors: r=R/(R+G+B), g=G/(R+G+B), b=B/(R+G+B) where R, G, and B are the color components of the input image. Such an index is used to convert an image into a bimodal image of non-green and green pixels. Other indices or models can also be used. Then this is followed by thresholding, for example otsu thresholding, to segment the image.

Skeletonization or skeletonizing is a process that transforms a mask into a thinned representation which can be imagined as contracting the mask along its major axis so that something similar to a 1-dimensional representation is obtained. This is very useful for applications such as length measurement if we have 2D maps and we want to study its properties. The process makes continuous iterations over the mask and on each loop removes neighboring pixels in a way such that they do not break the connectivity of that specific figure in the mask. This is done until the resulting output stops changing.

Line fitting is the process of constructing or obtaining a straight line best fitting to a block, range or series of data points.

An artificial neuron is a unit that imitates the biological neuron. It generally combines all the inputs weighing them with a factor and after summing followed by an activation function, communicates the output to other connected neurons.

There are many kinds of layers which exist in a neural network but two most important ones will be mainly discussed here. Dense layer connects every neuron in one layer to every neuron in the next layer by weights which can be learned. They are frequently used on most of the neural network designs but generally are very compute intensive. They were very common in early deep learning days but their usage have been replaced by other task specific layers which are more efficient. Convolution is an operation where a kernel is applied across the input and an element-wise product between each element of the kernel and the input is calculated and summed to compute a feature map. This is repeated to obtain multiple feature maps where each feature map learns a specific property of the input. The biggest advantage of a convolution operation is weight sharing and translational invariance which is very useful for reducing the learnable parameters and also ensuring better pattern finding in the input.

Activation functions are generally added to the output of neurons which adds nonlinearity to the decision-making process and hence gives more power for modeling the inputs to the outputs. There are many types of activation functions but the most popular ones are Sigmoid, Tanh, Relu, and Softmax.

Loss quantifies how correct the predictions made by the neural network are. They are generally task-specific and are required to be differentiable since the gradient from the loss is backpropagated back to the whole network for readjusting the weights to produce better predictions. There are 2 main classes in which losses are divided into Probabilistic losses (classification-based problems) and Regression losses (regression problems). Choice of a proper loss function is very important to capture the desired patterns in data. A very nice practical example of this is that of focal loss. When a model is trained using BCE loss which reinforces the fact that predict with more confidence, whereas, Focal Loss gives more freedom to the model to predict. Generally, an optimization scheme on top of the loss is used to rebalance the network to make the model the input-output pairs more efficiently.

Optimizers are algorithms that try to minimize the loss of the network by tweaking the parameters of the neural network. There are many popular optimizers such as Gradient Descent, Nesterov Accelerated Gradient (NAG), Adaptive Gradient (AdaGrad), RMSprop, Adam and Newtons method. They are divided into two broad categories First Order and Second Order Optimisers. First-order optimizers are more popular than second-order due to the ease of computation.

Image data augmentation is a method that generates new examples out of the dataset we have at hand by applying changes to the dataset images to generate new similar patterns which can help the model to learn more features and not overfit to our dataset. It is a form of regularization applied. It becomes very useful when there is a small number of samples in the dataset. Image augmentation adds both variations as well as quantity to our dataset. Commonly basic image transformations such as flipping, rotating, scaling, cropping, and color space shifting can be accomplished by leveraging classical image processing techniques. If the transformations making up an image augmentation pipeline are wisely chosen then it can make the model very robust. They are generally selected by a human experts but recently automatic methods which can learn to generate policies by learning the distribution of the training data are becoming popular.

Generative adversarial networks (GAN) build upon a game-theoretic concept where a generator competes with a discriminator. As the name suggests generator generates fake samples and the discriminator tells whether it is real or not. Both the networks in a competing way learn well and once the discriminator is not able to distinguish between real and fake training is brought to a halt. The generator then can be used separately after discarding the discriminator. The generator generating capacities are based on the training data distribution. Generator and discriminator compete against each other during the training process this game between them improves their functionalities progressively. The generator tries to minimize while the discriminator tries to maximize the GAN loss function. The loss function of GAN quantifies the similarity between the generative data and real data distribution by Jensen-Shannon divergence.

Using Jensen-Shannon Divergence Fails when Two Distributions are Disjoint Hence

Wasserstein distance is used since it is smoother. GAN which using Wasserstein distance is called a Wasserstein Generative Adversarial Network. The discriminator does not output between 0 or 1 but tries to make the output bigger for real examples than for fake. Such a discriminator is called a critic since it does not classify as real or fake. The discriminator tries to maximize the critic loss and the generator tries to maximize the generator loss. One big problem is to maintain the K-Lipschitz continuity of the above. Gradient clipping (clamp the weights between [0.01,0.01]) is proposed as a solution for this but a more flexible way to do enforce K-Lipschitz continuity is to add gradient penalty to the loss.

Faster AutoAugment proposes a differentiable policy search pipeline for image augmentation, which tries to find augmentation policy by search through the search space to minimize the distance between the distributions of augmented image and the original image hence keeping the whole process differentiable. Input images are augmented by a policy that consists of L different sub-policies (I=1, 2, . . . , L). A randomly selected sub-policy transforms each image X. A single sub-policy consists of K consecutive image processing operations O which are applied to the image one by one. We refer to the number of consecutive operations K as operation count.

Operations used in each sub-policy include affine transformations such as shear, color enhancing operations such as solarize, cutout, and sample pairing. Few operations have been associated whereas some have none. The searching operation is transformed into an optimization problem using Relaxed Bernoulli distribution which with a low temperature almost becomes equivalent to a Bernoulli distribution.

The goal of distribution minimization between original and augmented images can be achieved by minimizing the Wasserstein distance between these distributions using Wasserstein GAN. Here instead of using a conventional generator that learns to transform images using neural network layers, a policy is trained, and it transforms images using predefined operations, and the classifier heads with a two-layer perceptron that serves as a critic. Besides, a classification loss is added to prevent images of a certain class to be transformed into images of another class.

Semantic segmentation is defined as a problem of labeling each pixel of the image to a class to which it belongs. Basic semantic segmentation does not differentiate between different instances of the same class maps. It finds many practical usages mostly in autonomous driving and life sciences. An image can be described as a matrix of 3 channels (RGB image) which is mapped to a segmentation map that labels each image with an integer corresponding to the category to which it belongs. Semantic segmentation problem can be solved by many methods ranging from classical image processing methods such as Canny edge detection, watershed, histogram-based methods, and deep learning-based semantic segmentation models such as Unet, FPN, DeepLabV3, and Linknet. Generally for complex use cases, statistical methods break down whereas in presence of a good amount of data deep learning methods work well. One simple reason for the same is that often while segmenting the parts of the image we need a more complex heuristic of the neighboring areas of the pixel which needs to be given a class label which often requires more complex algorithms.

Feature pyramid Network (FPN) is inspired by featured image pyramid which is very commonly used in traditional classical computer vision techniques to achieve scale-invariant. This induces scale invariance and each different scale possesses different degrees of semantic information. Generally, a convolutional neural network creates a feature hierarchy while creating a feature pyramid that has crucial semantics at all scales but different layers have semantic gaps and these different layers cannot share semantic information. Hence a Feature Pyramid Network takes an image as an input and outputs feature maps at multiple scales in a fully convolutional manner. Any backbone can be used and hence this acts as a generic solution for building feature pyramids which can be used for tasks like object detection, region proposal network, and semantic and instance segmentation. Feature Pyramid Network combines information from all different scales using a bottom-up pathway, top-down pathway, and lateral connections via which it combines strong semantic information with the weak ones while making independent predictions at all levels. The bottom-up pathway is the forward computation of the backbone network, which computes a feature hierarchy consisting of feature maps at several scales. As one goes up the resolution decreases, with more high-level structures detected as we go further up. A top-down pathway is used to construct higher resolution layers from a semantic-rich layer. While the reconstructed layers are semantically strong but not precise after all the downsampling and upsampling. Lateral connections are added between reconstructed layers and the corresponding feature maps to help to make them more precise also acting like skip connections making the training more efficient. While going down the top-down path, the previous layer is upsampled by using interpolation like nearest neighbors upsampling. To generate the final segmentation map information from all levels of the Feature pyramid Network pyramid is merged into a single output.

EfficientNet is a family of next-generation convolutional neural networks. The main philosophy of efficient net is that balanced scaling up of dimensions of the depth (number of layers), width (number of channels), and image resolution (input image size) which would give the best overall performance. The intuition behind the above design decisions is that deeper networks can generalize well but difficult to train due to vanishing gradient issue, wider networks tend to be able to capture more fine-grained features and are easier to train, and in higher resolution input images networks can find finer patterns, so the goal becomes to find a perfect balance with all such factors to achieve the best performance. EfficientNet uses compound scaling for this. The first stage in the compound scaling technique is to conduct a heuristic search to determine the relationship between various aspects of the base network while working with a limited resource budget. The base network is then scaled up using those relationships. First, a base network is discovered via an automated mobile neural architecture search, which uses reinforcement learning to create compact models. Neural architecture search is a technique for automating the neural network design process. Neural architecture search is a much better alternative if executed properly as compared to designing a neural network with the help of a set of intuitions as it was done before. Slowly such auto search methods are becoming more popular. The resulting base model which is found using the search is then smoothly scaled up in a controlled way to obtain EfficientNets. In general, the EfficientNet models achieve the best accuracy by parameter ratio as compared to existing alternatives and also hugely reduces the number of floating-point operations providing an effective solution.

Differential learning rates mean using different learning rates for different parts of the model. General practice in the case of computer vision models especially when leveraging transfer learning is to train the first layer which learns general features with a slower learning rate so the weights are not changed rapidly and the later part of the model is trained with a higher learning rate. This is a contrast to using the same learning rate for the whole model and freezing the transfer learning layer works better especially in cases where the image domain at hand is different from ImageNet one which most of the transfer learning models are trained on. The intuition behind this method is that the first layers would contain very basic details of the data, such as the lines and the edges of which we normally would not want to change much. In contrast, in later layers where we get detailed features of the data, we might want to learn them fast by changing the weights more rapidly.

AdamW is just a correction to the already existing implementation of Adam with L2 regularization which exists in most deep learning libraries. Basically classical L2 in case of SGD with momentum:

$$movingavg = alpha * movingavg + ( 1 - alpha ) * ( w . grad + wd * w )$$

$$w = w - lr * movingavg ,$$

whereas weight decay looks like:

$$movingavg = alpha * movingavg + ( 1 - alpha ) * w . grad$$

$$w = w - lr * movingavg - lr * wd * w .$$

On average using weight decay properly with Adam can give us a good training routine that mostly generalizes well as shown in the experiments.

Learning rate schedules create a schedule that would change the learning rate dynamically as the training progresses based upon some condition. Cosine annealing learning rate scheduler is also one such scheduler. Cosine annealed warm restart learning schedulers are made up of two parts cosine annealing and warm restarts. Cosine annealing refers to using cosine function as the learning rate annealing method which is shown to perform better than linear annealing. Warm restarts means that the learning rate is restarted in simple words increased which is decayed later on. The strategy used for warm restarts is triangular with height descent. This kind of learning rate scheduling helps in exploring the loss surface well so that getting stuck in the local minima is prevented since it bounces around and then slowly stabilizes. Hence the probability to end up in the approximate global minima increases. In general, experimentally it is shown to provide better results than a constant learning rate schedule and there are many examples of the same.

It is always hard to choose the number of epochs for training a neural network since too high epochs can often lead to overfitting whereas the opposite can lead to underfitting. Hence Early Stopping is a technique that helps in setting a high number of epochs while initializing and then while training stops the training whenever validation loss stops decreasing after waiting for certain epochs. It is a common technique and can often be found in many research and application use cases.

Checkpointing is a process to resume training from a checkpoint if there are some system issues during the training of the model. Although model checkpointing can also be used for saving the model which gives a good performance on the validation set after each epoch. Generally, weights of the best performing model are kept saved throughout the training which can later be loaded for inference. Generally, model checkpointing monitors a certain metric and checks after each epoch which model gave the best performance concerning the metric either minimum or maximum. One can either monitor the main performance metric or even the validation loss. Different strategies can be used for checkpointing. Either checkpoint the model every time there is an improvement of the metric or checkpoint only the best model. It is used as a callback function that gets executed at the end of an epoch.

Stochastic Weight Averaging (SWA) is composed up of two steps. The first component of SWA is a custom learning rate schedule for any optimizer so that they can explore the loss region effectively as they wish. Hence this is used up for the first 75 percent of the training time. The second component comprises setting the learning rate to a constant value for the remaining 25 percent of the training time. An average of the weights of the networks traversed by the optimizer is then taken. After the full training, we then set the weights of the network to the computed averages. The main reason why it is a good trick to have while training the networks is that in flat loss regions normal optimizer converges around the boundary since there is not much signal to move further. Whereas in the case of SWA some movement happens around even in the flat regions than by averaging the results one reaches the center of such flat surface. Such results tend to generalize well as they are not as susceptible to the shifts between train and test error surfaces as at the boundaries.

Test Time Augmentation performs random modifications to the test images. Thus, instead of showing the clean plain images only once to the trained model, we will show the augmented images several times. Then some aggregation function such as mean is applied to the predictions of each corresponding image and then the final result is output out. The algorithm is as follows: input batch of images; apply augmentations (flips, rotation, scale, etc.); pass augmented batches through model; reverse transformations for each batch of masks/labels; merge predictions (mean, max, gmean, etc.); and output batch of masks/labels. The best aggregation function is temperature sharpen and augmentation strategies can be computing intensive hence plain ones such as flips and rotations works well.

Intersection over union is a metric which is used for evaluation of object detection and image segmentation systems. It borrows ideas from Jaccard Index and is defined as follows:

IoU=(Area of Overlap)/(Area of Union).

It is a very common evaluation metric that is often used in research as well as practical applications which simply measure the extent of overlap between two bounding boxes or masks.

Dice loss originates from Sørensen-Dice coefficient which was used to find similarity between two samples. Generally, Dice Loss is preferred over cross Entropy because one will likely see most of the pixel in an that is not the desired ground truth object. If one uses cross-entropy loss the algorithm may predict most of the pixel as ground truth even when they are not and still get low errors. But in the case of Dice Loss if the model predicts all the pixels as background the intersection would be 0 this would give rise to higher error. Dice loss is 1 Dice coefficient so that dice coefficient can be maximized.

Following is the workflow which shows the temporal order in which each conceptual block proceeds sequentially. All the building blocks are independent of each other but directly dependent on the output of the preceding stage. Moreover, this pipeline forms the complete problem-solving package ranging from data usage to usage by the farmer in the form of a failure map which can be used for monitoring the field. Annotations are done on patches coming from the input field image. Then auto augment which is an auto image augmentation technique is used to generate more data for the deep learning model. Data is consumed by the deep learning model which is a semantic segmentation computer vision architecture that learns to predict failure masks that correspond to the crop failure regions. These masks are then thinned and used to calculate percentage failure. All of these blocks are aggregated finally to give failure percentage for a 5×5 m patch in the field. These 5×5 m are finally combined and represent a failure map.

Augmentation is a crucial aspect of the data science pipeline but it is very difficult to find the processing which one should select as augmentations to make sure that augmented images are similar to the true data. The augmentation search generally requires heavy resources hence we have to be very clever in using the appropriate parameters for our task. Here we have few parameters to choose from as follows and we keep other parameters as default:

Number of sub policies—It is the number of distinct augmentation sub-policies. A random sub policy is selected in each loop and is applied to input data. The number of sub-policies that we use here is 20 since we found it gives us enough augmentations which can be tuned properly.

Number of chunks—Every data batch is split up into chunks and then a random sub policy is applied to each chunk. We used 4 here due to resource constraint.

Operation count—It is the number of augmentation operations that will be sequentially applied to each input data instance. operation count: 4 means that four sequential operations will be applied to each input. We keep it equal to 4 here since it gives us enough diversity and also is trainable in moderate time.

Network and epochs: For segmentation network we train a FPN with an EfficientNet B0 backbone and train for 20 epochs. The reasons for these design decisions are that the network trains fast and learns good policies.

In the following, design decision along with the algorithms will be discussed. Our choice of the model here is Feature Pyramid Network mainly for the reason that it is easier and more efficiently trainable with a modest number of parameters. For the backbone, we use Efficient Net since it has the best accuracy per parameters ratio amongst all the model models along with its already proven transfer learning capabilities. Here we experiment with B1, B2, and B3 versions of EfficientNet as it seems enough to solve the problem economically. For the optimization, we use AdamW and Cosine annealing learning rate schedule. These methods work best in practical applications as they provide very natural regularisation for better generalizability and ensures that the probability to end at the global minima is more. Moreover, these are the methods that seem to work best in real-world data situations since the test loss surface can be very noisy. For the loss, we generally have only two choices either cross-entropy or dice loss. After our preliminary experiments, we found that dice loss worked very well for the problem at hand. For the data augmentation policy, we use the policy as described above which served to be a game-changer here. The augmentation policy learned almost provided real-life simulation which helps the model to learn better and make sure most of the patterns are captured well. We also use model checkpointing as a callback here which saves the best performing model in validation data throughout the whole training duration. This makes sure that we in the end get the best performing model even if the model overfits through the whole training duration. After many experiments, we found that training till 150 epochs gives us good results eventually where after every 50 epochs we reduce the learning rate by a factor of 10 so that model converges slowly at later portions of training to not overshoot the possible global minima. We also trained the encoder at a slower learning rate as compared to the decoder because we wished to use its transfer learning capabilities coming from its pre-trained image net weights. This was also crucial for optimal training and ensured the training remained stable. After 50 epochs we enable Stochastic weight averaging and the intuition here is that at later parts of training it would be a nice idea to average weights to ensure that a nice movement can be induced to prevent being struck at loss minima regions and explore neighboring areas of loss surface a bit more. Stochastic weight averaging here in a way summarizes the training process. Between 100 to 150 epochs we also enable early stopping so that we can avoid some overfitting if possible.

The data augmentation can also be applied while making predictions so as to make predictions for multiple different versions of each image in the test data. The predictions on the augmented images can be merged together either averaging or taking harmonic mean or some aggregation function, which can lead to better results. The test set is also augmented by horizontal flipping of the images; the soft-max class posteriors of the original and flipped images are averaged to obtain the final scores for the image. TTAch (Image Test Time Augmentation with PyTorch!) is used here to serve the same purpose. The augmentation policy used here is fairly simple since it works best as compared to other complicated ones which tend to take more time but still giving similar performance also it does not burden the model to predict for too many versions of the test image.

Following is the final failure percentage calculation algorithm which gives us the final metric that informs how bad is the failure throughout the field. For crop mask, Computer Vision methods are used and the deep learning model is used to predict polygon map. The crop mask and the failure masks are used to compute the failure percentage. The failure percentage can be computed as the ratio of the masks' areas or their lengths.

In a preferred embodiment of the present invention, ExG index-based method is used and our deep learning model is used to predict polygon map from our method which later gets thinned by using morphological operation such as skeletonization which makes it simple to calculate length by simply just counting the number of pixels of the skeletonized output. The algorithm comprises: create crop mask using ExG thresholding and fix noise in the crop mask; use skeletonize operation on crop map; use skeletonize operation on output map; use region properties to filter out failures with length less than 51 cms creating failure mask; collect failure percentage for the test image via the equation;

Failure percentage=(Number of pixels in failure mask)/(Number of pixels in failure mask+Number of pixels in cropmask).

The final output is a failure map which is a map in which each grid represents a defined area and the color or other means of differentiation suggests the amount of failure that is there in that region in percentage. This is the output that will be useful for the farmer to decide which region of the field needs more supervision. The region in which failure maps are calculated is called the field boundary which is generally smaller than the full field size (in this case the quadrilateral which shows the failure map).

The following embodiments 1 to 9 are also preferred embodiments of the present invention:

### EMBODIMENT 1

Method for generating a crop failure map, the method comprising:
providing annotated training data, the annotated training data comprising aerial images of zones of an agricultural field and the annotations relating to failures of the crops within the agricultural field, the crops being perennial crops; training an artificial intelligence with the annotated training data; providing (test) field data, the (test) field data comprising at least one aerial image of an agricultural field to be inspected; running the trained artificial intelligence on the (test) field data to generate an initial failure map; skeletonizing the initial failure map to generate a crop failure row map comprising rows of failures.

### EMBODIMENT 2

Method according to Embodiment 1, the method further comprising:
determining the crop failure percentage from the crop failure row map for a plurality of sub-zones of the agricultural field; assigning the determined crop failure percentage to the sub-zones; and generating a crop failure percentage map indicating the crop failure percentage for each of the sub-zones.

### EMBODIMENT 3

Method according to any of the Embodiments 1 or 2, wherein the sub-zones are squares and the squares have, in particular, an edge length of 10 m, preferably 5 m, more preferably 2 m.

### EMBODIMENT 4

Method according to any of the Embodiments 1, 2 or 3, the method further comprising: providing initial annotated training data, the initial training data comprising aerial images of zones of an agricultural field and the annotations relating to failures of the crops within the agricultural field; and auto-augmenting the initial annotated training data to generate the annotated training data.

### EMBODIMENT 5

System for generating a crop failure map, the system comprising:
an input unit for providing annotated training data and for providing (test) field data; and
a computing unit configured to execute the method according to any of Embodiments 1 to 4.

### EMBODIMENT 6

Computer program element which when executed by a computing unit in a system according to Embodiment 5 is configured to carry out a method according to any of Embodiments 1 to 4.

### EMBODIMENT 7

Computer readable medium that generates data to control a computing unit in a system according to Embodiment 5 according to the method according to any of Embodiments 1 to 4.

### EMBODIMENT 8

Use of a crop failure map to identify crop failure regions of an agricultural field with perennial crops.

### EMBODIMENT 9

Use according to Embodiment 8, wherein crops are re-planted in the identified crop failure regions.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows images of crop rows;

FIG. 2 shows an example from a testing routine (left part: image; center part: ground truth mask; right part: predicted mask);

FIG. 3 shows an output map (a) Black: Ground Truth; b) Yellow: Prediction);

FIG. 4 shows a prediction on a field;

FIG. 5 shows an overestimation of crop lengths;

FIG. 6 shows failures in no crops region;

FIG. 7 shows a failure map; and

FIG. 8 shows a map and its skeletonization.

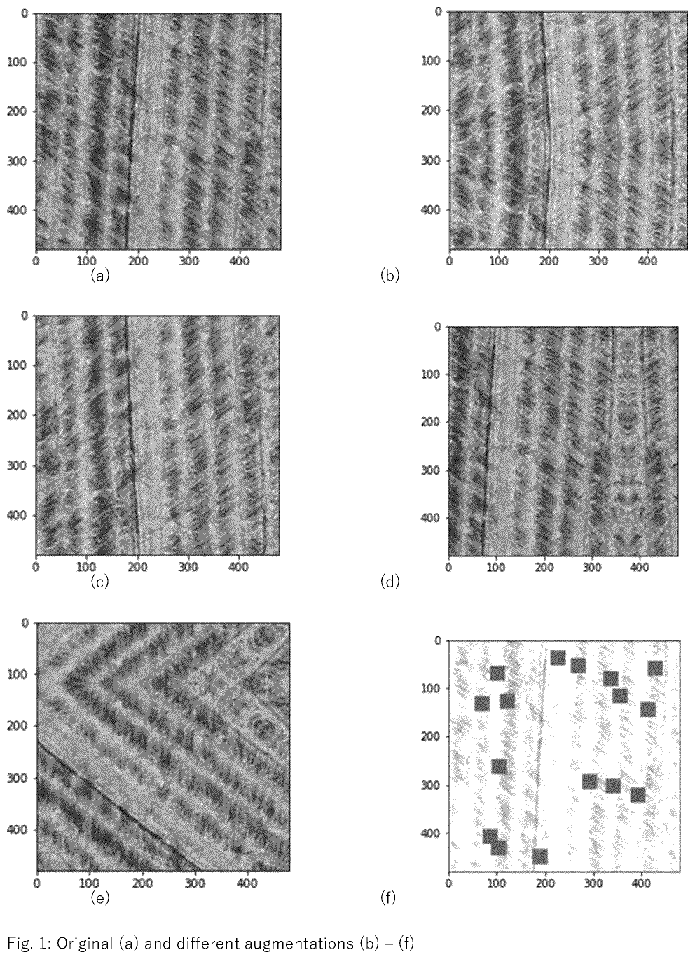

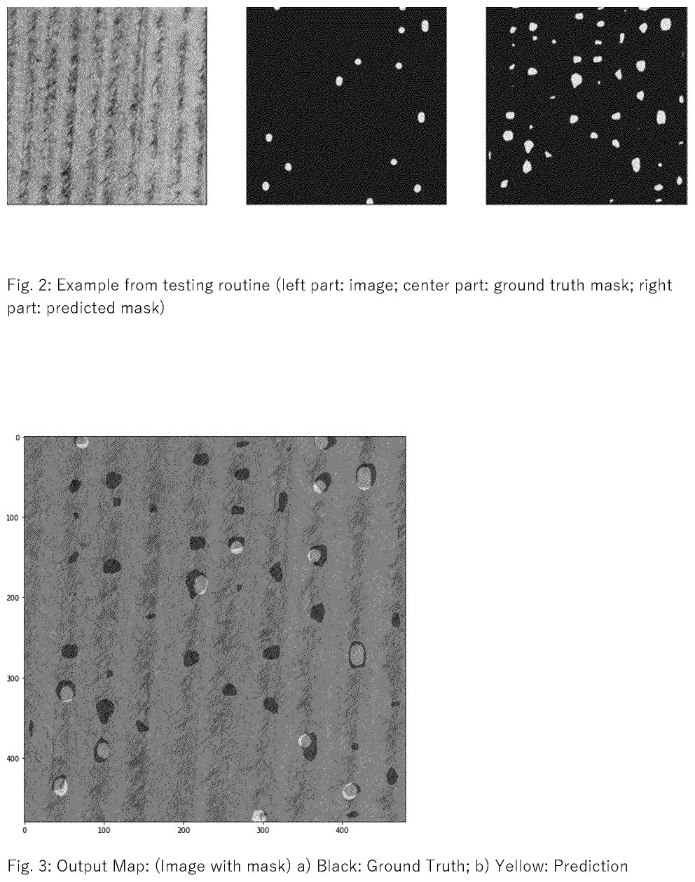

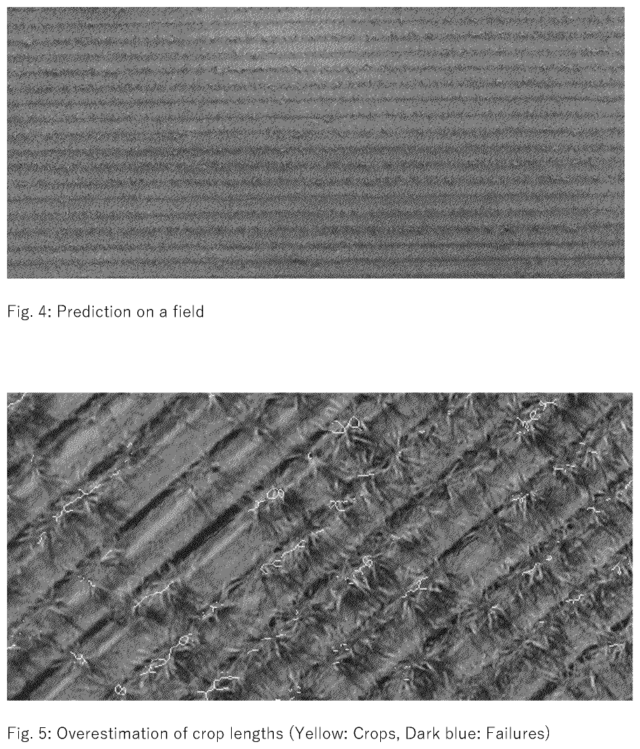

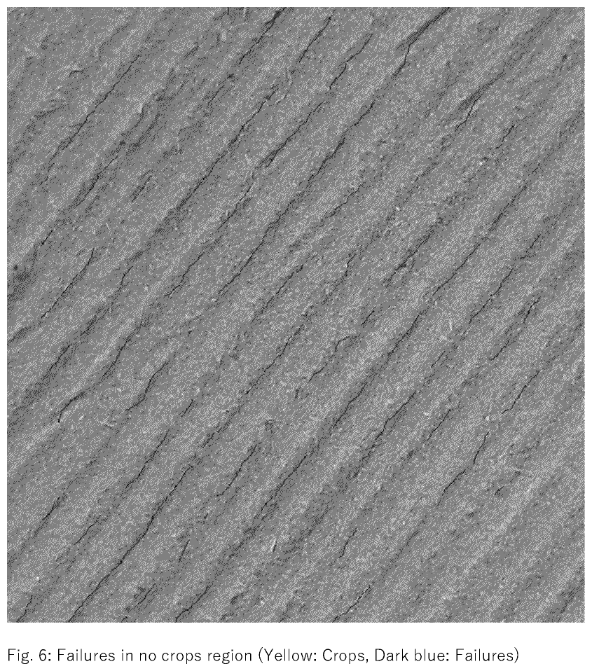

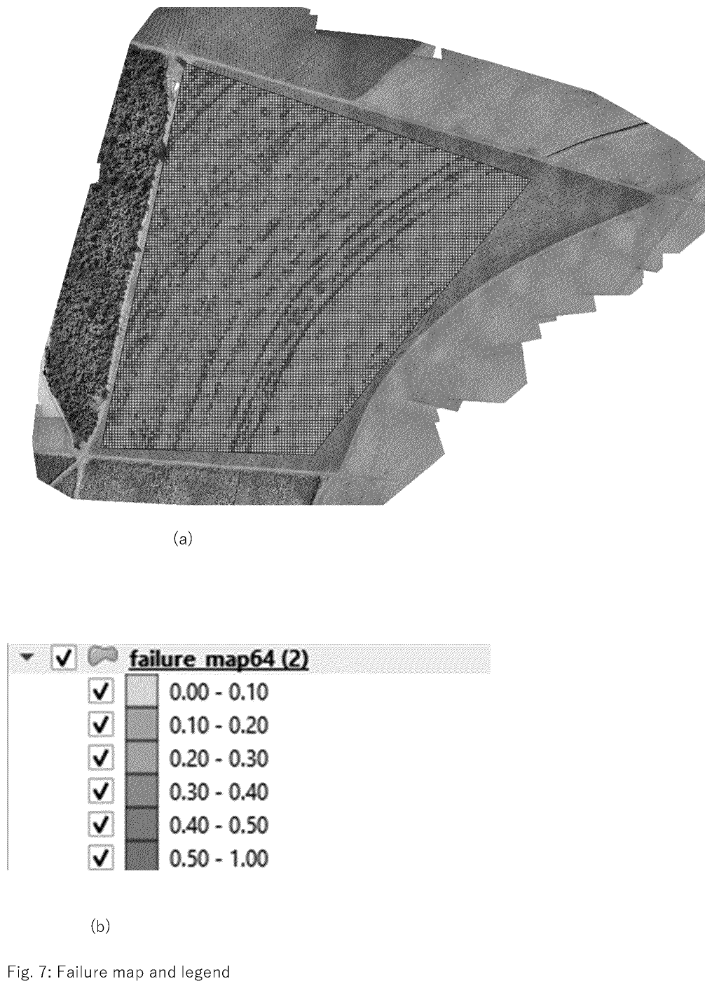

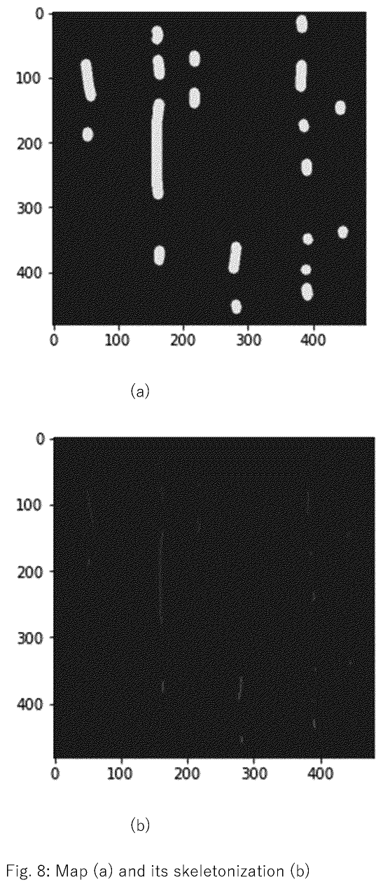

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

1. A method for generating a crop failure map, the method comprising:
providing annotated training data, the annotated training data comprising aerial images of zones of an agricultural field and the annotations relating to failures of the crops within the agricultural field, the crops being perennial crops;
training an artificial intelligence with the annotated training data; providing field data, the field data comprising at least one aerial image of an agricultural field to be inspected; and
running the trained artificial intelligence on the field data to generate an crop failure map.

2. The method according to claim 1, further comprising:
determining crop failure length by modifying the crop failure map by skeletonizing, line fitting and/or other crop failure length estimation.

3. The method according to claim 1, further comprising:
skeletonizing the crop failure map to generate a crop failure row map comprising rows of failures.

4. The method according to claim 1, the method further comprising:
identifying crop failure regions in the crop failure map or crop failure row map and outputting a control file usable to control an agricultural equipment for re-planting crops in the identified crop failure regions.

5. The method according to claim 1, further comprising:
determining the crop failure percentage from the crop failure map for a plurality of sub-zones of the agricultural field;
assigning the determined crop failure percentage to the sub-zones; and
generating a crop failure percentage map indicating the crop failure percentage for each of the sub-zones.

6. The method according to claim 1, further comprising:
determining the crop map by indices calculation with thresholding or artificial intelligence and determining the crop length by modifying the crop map by skeletonizing, line fitting and/or other crop length estimation, determining the crop failure percentage from the crop failure map for a plurality of sub-zones of the agricultural field and from the crop map of the same area;
assigning the determined crop failure percentage to the sub-zones; and
generating a crop failure percentage map indicating the crop failure percentage for each of the sub-zones.

7. The method according to claim 1, further comprising:
determining the crop map by excess green index (ExG) calculation with Otsu thresholding and determining the crop length by modifying the crop map by skeletonizing, line fitting and/or other crop length estimation, determining the crop failure percentage from the crop failure map for a plurality of sub-zones of the agricultural field and from the crop map of the same area;
assigning the determined crop failure percentage to the sub-zones; and
generating a crop failure percentage map indicating the crop failure percentage for each of the sub-zones.

8. The method according to claim 1, wherein the sub-zones are squares and the squares have, in particular, an edge length of 10 meters or less, enabling a user to point to the location of the failure and deciding on any necessary actions.

9. The method according to claim 1, wherein the sub-zones are squares and the squares have, in particular, an edge length of 10 m.

10. The method according to claim 1, the method further comprising:
providing initial annotated training data, the initial training data comprising aerial images of zones of an agricultural field and the annotations relating to failures of the crops within the agricultural field; and
auto-augmenting the initial annotated training data to generate the annotated training data.

11. A system for generating a crop failure map, the system comprising:
an input unit for providing annotated training data and for providing field data; and
a computing unit configured to execute the method according to claim 1.

12. (canceled)

13. A computer readable medium having instructions encoded thereon that, when executed by a computing unit, cause the computing unit to perform the method according to claim 1.

14. Use of a crop failure map to identify crop failure regions of an agricultural field with perennial crops, the crop failure map being generated according to a method of claim 1.

15. The use according to claim 14, wherein crops are re-planted in the identified crop failure regions.
